(19) United States
(12) Patent Application Publication
(10) Pub. No.: US 2007/0278857 A1
(43) Pub. Date: Dec. 6, 2007

(54) Mid-Link Powered Device for Power over Ethernet

(76) Inventor: Steven Andrew Robbins, (US)

Correspondence Address: Steve Robbins, Unit A, 26007 Alizia Canyon Drive, Calabasas, CA, 91302, US

(21) Appl. No.: 11/539,620

(22) Filed: Oct. 6, 2006

Related U.S. Application Data
(60) Provisional application No. 60/803,706, filed on Jun. 1, 2006.
(60) Provisional application No. 60/804,212, filed on Jun. 8, 2006.

(51) Int. Cl. H02J 3/02

(52) U.S. Cl. 307/2

(57) ABSTRACT

A method and apparatus with several embodiments for powering two Powered Devices (PD's) in a Power over Ethernet (PoE) system from a single computer network cable, where the cable is carrying power from both an endspan Power Sourcing Equipment (PSE) and a midspan PSE. The apparatus is a special type of PD that resides in the middle of the link segment and is hence referred to as a “mid-link PD”. The mid-link PD utilizes power from one PSE and passes power from the other PSE along to another PD at the end of the link segment: This eliminates the need to install additional network cabling in order to power a second PD in a location where a first PD is already receiving power.

### CROSS-REFERENCE TO RELATED APPLICATIONS

This application claims priority from two U.S. Provisional Patent Applications: application number 60/803,706 titled An apparatus that allows an IP telephone to select between two PoE sources, and pass one source to another PD filed on Jun. 1, 2006; and application number 60/804,212 titled An apparatus that allows a PD to select between two PoE sources, and pass one source to another PD filed on Jun. 8, 2006.

### TECHNICAL FIELD OF THE INVENTION

The invention relates generally to the field of Power over Ethernet (PoE); a system that provides power over computer data network wiring.

### BACKGROUND OF THE INVENTION

The IEEE issued an amendment to IEEE Std 802.3™-2002; this amendment, titled Data Terminal Equipment (DTE) Power via Media Dependent Interface (MDI), was published as IEEE Std 802.3af™-2003, and is hereinafter referred to as the “IEEE standard”. The IEEE standard, whose contents are incorporated herein by reference, is commonly referred to as Power over Ethernet (PoE), and specifies methods and requirements for delivery of limited DC power using two of the four conductor pairs contained within standard Ethernet cables. Equipment that supplies power on Ethernet cables are called Power Sourcing Equipment (PSE), of which there are two types, endspan and midspan, distinguishable by their location within the link segment. Any apparatus that utilizes power supplied by a PSE is called a Powered Device (PD).

A typical PoE installation includes an Ethernet switch with either an internal endspan PSE, or an external midspan PSE. The switch and PSE are typically in a central location, such as a data closet, and run off power from an Uninterruptible Power Source (UPS). Network cables radiate out from the PSE to all the PD's in the building. The most common PoE installation is an office building with a single PD (an IP telephone) in each office.

FIG. 1 shows a block diagram of a conventional PoE system 10 wherein a PSE 11 contains at least two ports. A first PSE port 12 powers a first Powered Device (PD) 16 via a network cable 14; and a second PSE port 13 powers a second PD 17 via another network cable 15. The purpose of this example is to illustrate that every PD needs a dedicated network cable running back to the PSE 11.

Users who wish to have a second PD in their office would normally need to run a second network cable through the building. In a typical office building, network cables often run long distances through plenums, and sometimes pass through walls or floors; installing such cables often requires electricians or other trained professionals, often at considerable expense.

### SUMMARY OF THE INVENTION

Accordingly, it is a principal objective of the present invention is to overcome a major disadvantage of conventional PoE systems by providing an inexpensive means to power two PD's over a single network cable. The invention includes a method and apparatus, each with several embodiments described below.

One embodiment of the method includes steps of: providing power on all four conductor pairs within a network cable by connecting a first PSE port to two conductor pairs, and a second PSE port to the other two conductor pairs; using power from the first PSE port to power a first PD in the middle of the link segment (this first PD is hereinafter referred to as a “mid-link PD”); and passing power from the second PSE port through the mid-link PD to a second PD at the end of the link segment.

In another embodiment of the method, the step of passing power from the second PSE port through the mid-link PD to a second PD, is contingent upon and in response to the first PSE port powering the mid-link PD; if the first PSE port doesn't apply power to the mid-link PD, then the second PSE port may power the mid-link PD.

One embodiment of the apparatus includes: a first network interface connector, with a first group of contacts and a second group of contacts; a second network interface connector with a first group of contacts and a second group of contacts; logic circuitry operable to act as a network hub, switch, or repeater conveying network data between at least the first and second network interface connectors; transformers arranged to AC-couple computer network data signals from both connectors to the logic circuitry; a PD controller circuit connected to draw power from the first group of contacts on the first network interface connector via a bridge rectifier; a power supply that gets power from the PD controller circuit; and circuit pathways that convey power between the second group of contacts on the first network interface connector, and the second group of contacts on the second network interface connector.

In one embodiment, the apparatus described above includes additional rectifiers arranged in a diode-OR configuration, allowing the PD controller to draw power from either the first group of contacts on the first network interface connector, or the first group of contacts on the second network interface connector.

In another embodiment the apparatus includes: a first network interface connector, with a first group of contacts and a second group of contacts; a second network interface connector with a first group of contacts and a second group of contacts; logic circuitry operable to act as a network hub, switch, or repeater conveying network data between at least the first and second network interface connectors; transformers arranged to AC-couple computer network data signals from both connectors to the logic circuitry; a first rectifier circuit connected to draw power from the first group of contacts on the first network interface connector; a second rectifier circuit connected to draw power from the second group of contacts on the second network interface connector; a PD controller circuit connected to utilize power output from either the first or second rectifier circuits; a power supply that gets power from the PD controller circuit; and circuit pathways that DC-couple power from the second group of contacts on the first network interface connector, to the first group of contacts on the second network interface connector.

In another embodiment the apparatus includes: a first network interface connector, with a first group of contacts and a second group of contacts; a second network interface connector with a first group of contacts and a second group of contacts; logic circuitry operable to act as a network hub, switch, or repeater conveying network data between at least the first and second network interface connectors; transformers arranged to AC-couple computer network data signals from both connectors to the logic circuitry; a first rectifier circuit connected to draw power from the first group of contacts on the first network interface connector; a second rectifier circuit; a power switch; a PD controller circuit connected to utilize power output from either the first or second rectifier circuits; and a power supply that draws power from the PD controller circuit. The power switch has at least two states: a first state wherein the power switch routes power from the second group of contacts on the first network interface connector to the second rectifier circuit; and a second state wherein the power switch routes power from the second group of contacts on the first network interface connector to the second group of contacts on the second network interface connector.

In another embodiment the apparatus includes: a first network interface connector, with a first group of contacts and a second group of contacts; a second network interface connector with a first group of contacts and a second group of contacts; logic circuitry operable to act as a network hub, switch, or repeater conveying network data between at least the first and second network interface connectors; transformers arranged to AC-couple computer network data signals from both connectors to the logic circuitry; a first rectifier circuit connected to draw power from the first group of contacts on the first network interface connector; a second rectifier circuit connected to draw power from the second group of contacts on the first network interface connector; a first PD controller circuit connected to utilize power output from the first rectifier circuit; a second PD controller circuit connected to utilize power output from the second rectifier circuit; a power switch that, when closed, carries power from the second group of contacts on the first network interface connector, to the second group of contacts on the second network interface connector; and a power supply that can draw power from either the first or second PD controller circuits.

### BRIEF DESCRIPTION OF THE DRAWINGS

For a more complete understanding of the invention and to show how the same may be carried into affect, reference will now be made, purely by way of example, to the accompanying drawings:

FIG. 1 shows a block diagram of a conventional PoE system, wherein a PSE powers two separate PD's;

FIG. 2 shows a block diagram of a novel system in accordance with the teachings of the invention;

FIG. 3 shows a simplified schematic diagram that depicts the system of FIG. 2 in more detail, and a first embodiment of the invention;

FIG. 4 shows a simplified schematic diagram of another embodiment of the invention;

FIG. 5 shows a simplified schematic diagram of yet another embodiment of the invention;

FIG. 6 shows a simplified schematic diagram of yet another embodiment of the invention; and

FIG. 7 shows a simplified schematic diagram of yet another embodiment of the invention.

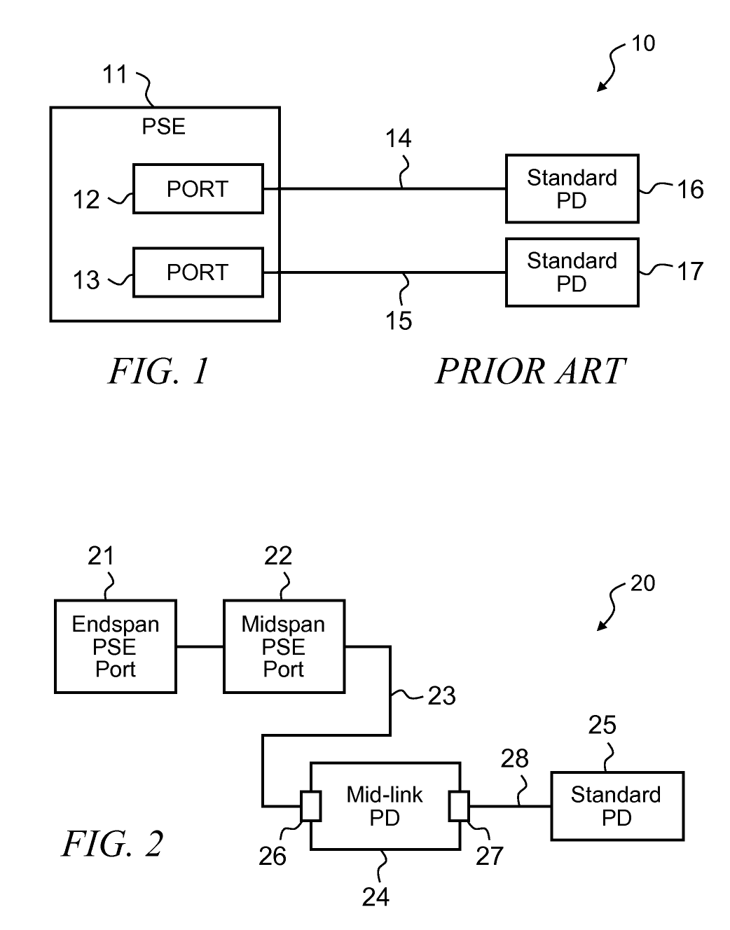

### DETAILED DESCRIPTION OF EXAMPLE EMBODIMENTS OF THE INVENTION

FIG. 2 shows a block diagram of a novel system 20 that allows two Powered Devices (PD's) 24 and 25 to be powered via a single network cable 23. The network cable 23 contains four pairs of wires; the endspan Power Sourcing Equipment (PSE) port 21 supplies power on two of these conductor pairs, and the midspan PSE port 22 supplies power on the other two conductor pairs. The invention is a special type of PD, hereinafter referred to as a “mid-link PD” 24. (In contrast, a “standard PD”, such as 25, is one that conforms to the IEEE standard.)

The mid-link PD 24 utilizes power from one of the PSE ports and conveys power from the other PSE port to another PD at the end of the link segment. In the example of FIG. 2 the PD at the end of the link segment is a standard PD 25, but it could be another mid-link PD: Therefore, to keep the explanation of the present invention general, the PD at the end of the link segment is hereinafter referred to as the “end-PD”.

An advantage of the mid-link PD 24 is that it can be installed without laying in a second network cable: For example, suppose system 20 initially has only one PD 25, and cable 23—a long cable running through the walls or plenums of the building—connects directly to the standard PD 25. A user could easily install the mid-link PD 24 by disconnecting cable 23 from the standard PD 25, connecting cable 23 to the input connector 26 on the mid-link PD 24, and connecting a second network cable 28 from the output connector 27 of the mid-link PD 24 to the end-PD 25. No new network cable must be routed through the infrastructure of the building.

Before describing the details of any example embodiments, two points should be noted: first, for the purpose of simplicity, all the simplified schematic diagrams show apparatus that are adapted to handle data rates up to 100 Mbps (using only two conductor pairs to carry data), but embodiments that are adapted to carry higher rates, for example 1000 Mbps traffic (using all four conductor pairs to carry data) are also claimed; and second, for the purpose of example only, all connectors shown in the simplified schematics are RJ45 type, and the pin assignments are as defined by the IEEE standard, but the invention is not limited to this specific case and embodiments utilizing alternative connector types or pin-assignments are also claimed.

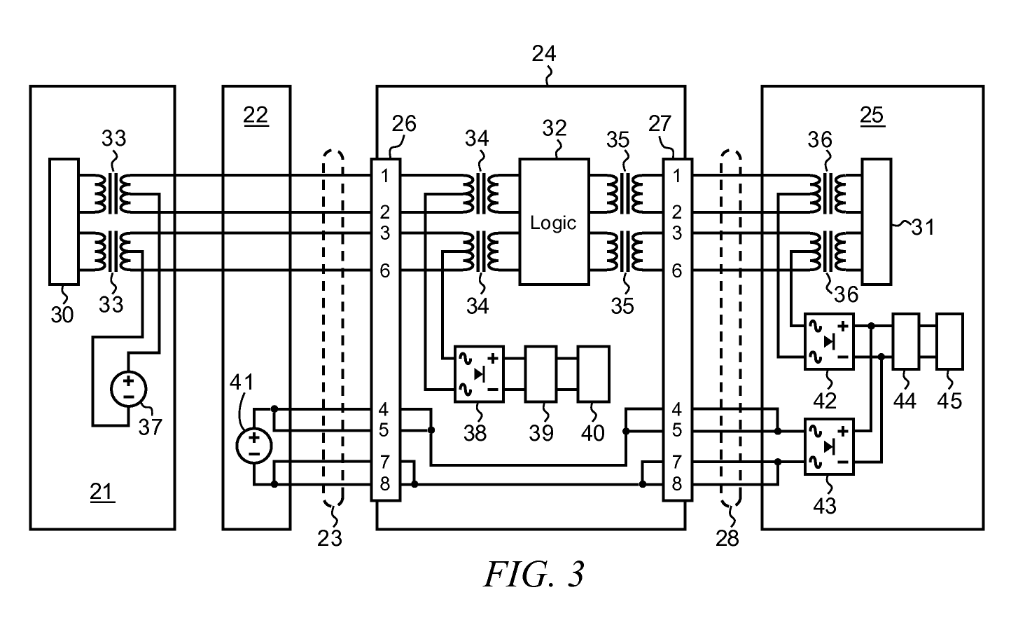

FIG. 3 shows a simplified schematic of the system 20 of FIG. 2, and a first embodiment of the present invention 24. The endspan PSE port 21, midspan PSE port 22, mid-link PD 24, and standard PD 25 are all on the same link segment (but the midspan PSE port 22 passively conveys network data signals, and does not participate in any network communications in this link segment). The ends of the link segment are the physical interface (PHY) controllers 30 and 31, and the logic 32 in the mid-link PD 24 acts as either a hub, switch, or repeater for the network data, allowing both PD's (24 and 25) to communicate with the endspan PSE 21. The network data is in the form of differential-mode signals, and these signals are AC-coupled between the PHY controllers (30 and 31) and the mid-link logic 32 by transformers 33, 34, 35, and 36.

For the purpose of simplifying the explanation of the present invention, the complex circuitry inside the PSE ports that handles all the functions defined in the IEEE standard (detection, classification, current limiting, PD-disconnect sensing, etc.) are depicted in FIG. 3 as simple voltage source symbols 37 and 41.

Power from the endspan-PSE source 37 is conveyed to the mid-link PD 24 as a common-mode signal via transformers 33, midspan PSE port 22, and the data-pairs within the network cable 23; inside the mid-link PD 24 the common-mode power is extracted from the center-taps of transformers 34, rectified by a bridge rectifier 38, and passed to a power supply 40 by a PD controller 39. The PD controller 39 handles all the PD functions defined by the IEEE standard (detection, classification, in-rush current limiting, etc.).

Power from the midspan-PSE source 41 is conveyed to the mid-link PD 24 as a common-mode signal on the spare-pairs within the network cable 23; the power is passed through the mid-link PD 24, and thence to the end-PD 25 via a second network cable 28. Inside the end-PD 25 the power is rectified by bridge rectifier 43, and passed to power supply 45 by PD controller 44.

The embodiment of the mid-link PD 24 shown in FIG. 3 has two basic problems: first, if the cables 23 and 28 are connected incorrectly, such that connectors 26 and 27 are swapped, then the mid-link PD 24 will not receive power; and second, the mid-link PD 24 can only draw power from an endspan PSE, so it won't work in a system that has only a midspan PSE (in contrast, a standard PD such as 25 can work with either an endspan or midspan PSE). The next several embodiments, described below, address these problems.

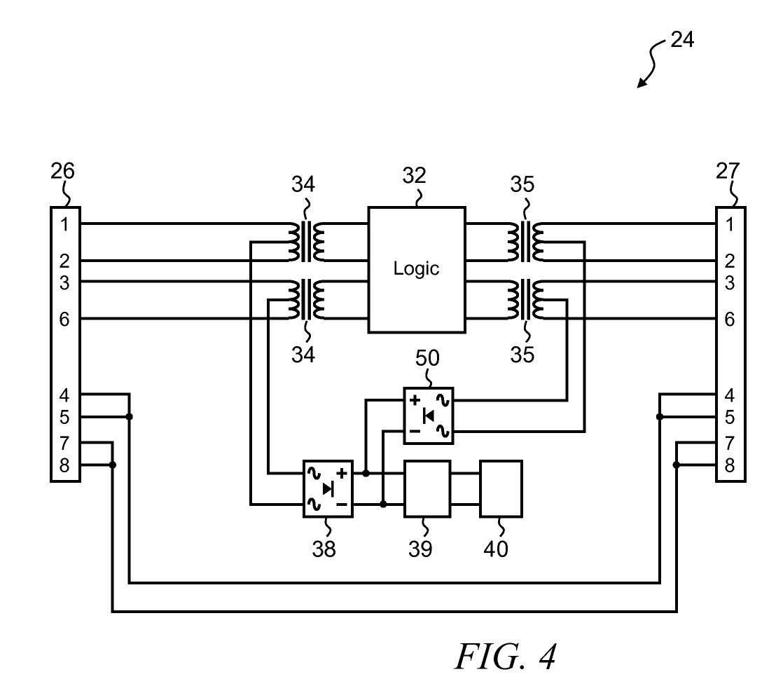

FIG. 4 shows a simplified schematic of another embodiment of the invention 24, similar to the embodiment of FIG. 3, but including a second bridge rectifier 50 connected to the first bridge rectifier 38 in a “diode-OR” arrangement, such that either bridge rectifier can supply power to the PD controller 39. The purpose of the second bridge rectifier 50 is to make the mid-link PD 24 electrically symmetrical, so that it doesn't matter which connector (26 or 27) the midspan PSE 22 connects to, or which connector the end-PD 25 connects to: This makes it impossible for a user to connect the cables (23 and 28) incorrectly.

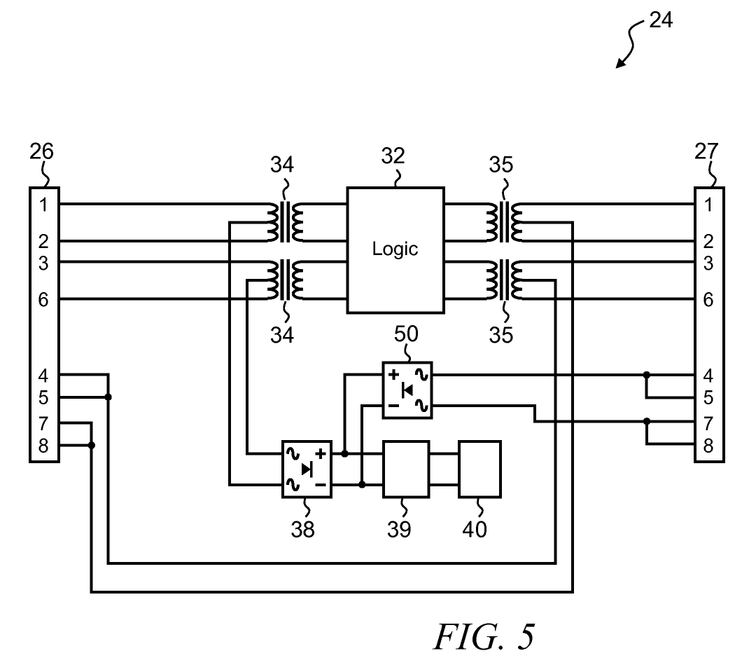

FIG. 5 shows a simplified schematic of another embodiment of the invention 24, similar to the embodiment of FIG. 4, but with power cross-coupling; power is conveyed between pins 4, 5, 7, and 8 on connector 26, and 1, 2, 3, and 6 on connector 27. If the system is connected as shown in FIG. 2 then the mid-link PD 24 runs off power from the endspan PSE port 21, and the end-PD 25 runs off power from the midspan PSE port 22. However, if the network cables are reversed, such that cable 23 goes to connector 27 and cable 28 goes to connector 26, then the mid-link PD 24 is powered by the midspan PSE port 22 and the end-PD 25 is powered by the endspan PSE port 21. This allows the user to decide which PSE powers each PD simply by connecting the cables in different ways.

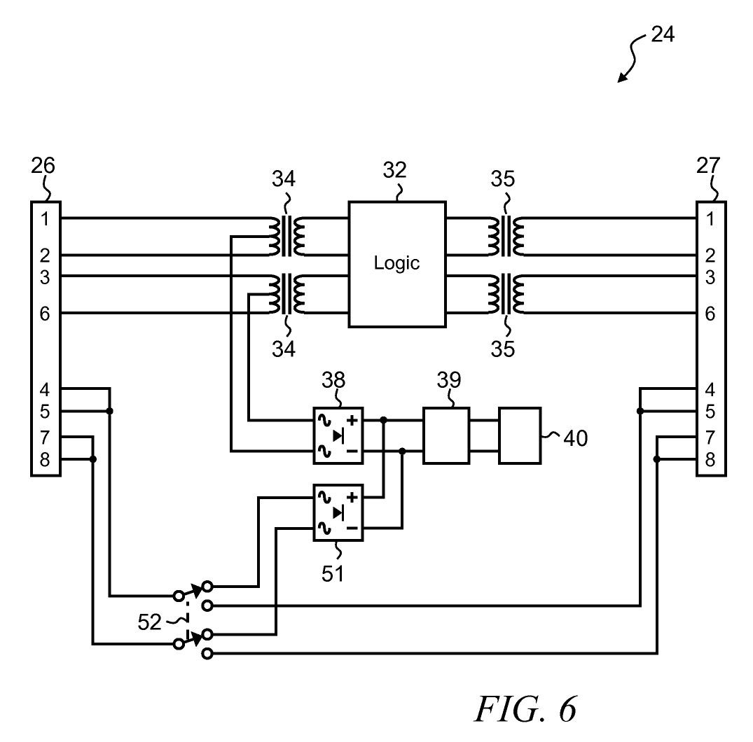

FIG. 6 shows a simplified schematic of another embodiment of the invention 24, similar to the embodiment of FIG. 3, but including a second bridge rectifier 51 and a power switch 52. When the power switch 52 is in first state (the position shown in FIG. 6), the mid-link PD 24 acts like a standard PD and is able to draw power from either the endspan PSE port 21 or midspan PSE port 22. However, when the power switch 52 is in a second state (the other position), the apparatus acts like the mid-link PD 24 of FIG. 3; it conveys power from the midspan PSE port 22 to the end-PD 25 via connector 27.

In one embodiment, the power switch 52 shown in FIG. 6 is simply a mechanical switch such as a toggle switch or a slider switch: The user selects the power switch state manually.

In another embodiment, the power switch 52 shown in FIG. 6 is a relay (either mechanical or solid-state) that is controlled by circuitry that senses voltage at the inputs of the two bridge rectifiers, and drives the relay in response to determining if the sensed voltages are above or below some predetermined thresholds. If the voltage magnitude at the input of the first bridge rectifier 38 is above a predetermined threshold (indicating the endspan PSE 21 is powering the mid-link PD 24) and the voltage magnitude at the input of the second bridge rectifier 51 is below another predetermined threshold (indicating that the midspan PSE 22 is either absent, or is running detection cycles), then the power switch 52 is set to said second state, connecting the midspan PSE 22 to the end-PD 25 via connector 27; otherwise the power switch 52 is in said first state.

In another embodiment, the power switch 52 shown in FIG. 6 is a relay (either mechanical or solid-state) and control circuitry changes the state of the power switch 52 in response to a message or command received by the logic circuit 32 via transformers 34 or 35.

A disadvantage of the apparatus depicted in FIG. 6 is that it requires the endspan PSE 21 to detect and power the mid-link PD 24 before the midspan PSE 22 does: If the midspan PSE 22 detects and powers the mid-link PD first, then the power switch 52 will remain in the first state, and the end-PD 25 will not receive power. When both the endspan PSE 21 and midspan PSE 22 conform to the original IEEE standard, the endspan PSE 21 will always power the mid-link PD 24, because the IEEE standard requires the midspan PSE to periodically include a back-off interval between detection cycles, while the endspan PSE has no back-off interval, and can run detection cycles contiguously. However, this may not be the case for future versions of the IEEE standard; this problem is addressed by the next embodiment described below.

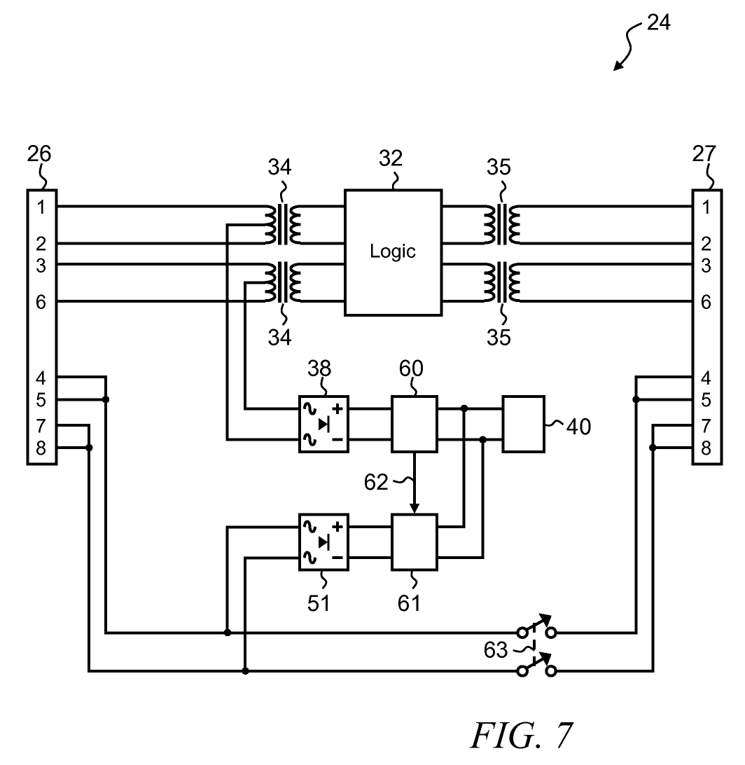

FIG. 7 shows a simplified schematic of another embodiment of the invention 24, which overcomes the disadvantage of the apparatus of FIG. 6 described above. In this embodiment, a first PD controller 60 includes control circuitry that outputs a signal 62, and that signal is received by a second PD controller 61. If at any time the endspan PSE port 21 applies power to the mid-link PD 24, the first PD controller 60 responds by disabling the second PD controller 61 via the control signal 62. When the second PD controller 61 is disabled, it stops conducting current from the second bridge rectifier 51 to the power supply 40, and appears as a high-impedance to the midspan PSE port 22 (the detection and classification functions of the PD controller 61 are also disabled). Some small amount of current may still flow into the second PD controller 61 while it's disabled, but that current is below the minimum specified in the IEEE standard to maintain power from a PSE. If the midspan PSE port 22 was supplying power to the mid-link PD 24 before the endspan PSE port 21, then the disabled PD controller 61 will appear to the midspan PSE port 22 like an open circuit, and the midspan PSE port 22 will respond to seeing the open circuit by discontinuing power. Once the voltage at the input of the second PD controller 61 falls below a predetermined threshold, control circuitry responds by closing the power switch 63; thus allowing the midspan PSE port 22 to detect and subsequently power the end-PD 25 through the closed power switch 63.

In one embodiment, the power switch 63 is a latching relay that latches (closes the relay contacts) when the voltage at the input of the first PD controller 60 is above a predetermined threshold and voltage at the input of the second PD controller 61 is below another predetermined threshold; and the switch 63 unlatches (relay contact open) when the voltage at the inputs of both PD controllers (60 and 61) fall below a predetermined threshold. This method of controlling the switch 63 allows the two loads (mid-link PD 24, and end-PD 25) to be controlled individually; the endspan PSE port 21 can turn off power to the mid-link PD 24, while the midspan PSE port 22 still powers the end-PD 25 via the latched power switch 63.

Although the present invention has been described with several embodiments, a myriad of changes, variations, alterations, transformations, and modifications may be suggested by one skilled in the art, and it is intended that the present invention encompass such changes, variations, alterations, transformations, and modifications as they fall within the scope of the appended claims. Some examples of changes, variations, alterations, transformations, and modifications includes: the addition of common-mode terminations to reduce radiated emissions from cables; additional bridge rectifiers disposed to make the apparatus depicted in FIG. 6 or FIG. 7 electrically symmetrical; additional states for power switches; circuitry operable to reduce transients when a power switch state is changed; or additional transformers and logic allowing the mid-link PD to carry gigabit Ethernet traffic.

What is claimed is:

1. A method of powering two Powered Devices (PD) from a single network cable, said network cable having at least four conductor pairs adapted to carry computer network data, said method comprising steps of:
providing power on said at least four conductor pairs within said network cable by connecting a first Power Sourcing Equipment (PSE) port to two of said four conductor pairs, and connecting a second PSE port to the other two of said four conductor pairs;
utilizing power drawn from said first PSE port via said network cable to power a first PD; and
conveying power from said second PSE port through said first PD to power a second PD.

2. The method of claim 1 wherein said step of conveying power from said second PSE port through said first PD to said second PD, is contingent upon and in response to said first PSE powering said first PD.

3. The method of claim 2 wherein said first PD utilizes power from said second PSE port until said first PSE port sources power to said first PD.

4. A Powered Device (PD) apparatus that utilizes power from a first PSE port, and conveys power from a second PSE port to a second PD, both said PSE ports supplying power to said apparatus via the same computer network cable, said apparatus comprising:
a first connector providing an interface to said computer network cable, said first connector including a first group of contacts receiving power from said first PSE port, and a second group of contacts receiving power from said second PSE port;
a second connector providing an interface to said second PD, said second connector including a first group of contacts and a second group of contacts;
logic circuitry operable to at least convey computer network data between said first connector and said second connector;
a first group of transformers arranged to AC-couple said computer network data between said first connector and said logic circuitry;
a second group of transformers arranged to AC-couple said computer network data between said second connector and said logic circuitry;
a full-wave rectifier circuit with inputs connected to said first group of contacts on said first connector via said first group of transformers;
a Powered Device (PD) controller circuit connected to draw power from the output of said full-wave rectifier circuit;
a power supply circuit with inputs connected to the outputs of said PD controller circuit, said power supply circuit supplying power to at least said logic circuitry; and
circuit pathways that convey DC power from said second group of contacts on said first connector to said second group of contacts on said second connector.

5. The apparatus of claim 4 and further comprising an additional full-wave rectifier circuit with inputs connected to said first group of contacts on said second connector via said second group of transformers, and outputs connected to the inputs of said PD controller circuit.

6. The apparatus of claim 4 wherein said circuit pathways convey DC power from said second group of contacts on said first connector via said first group of transformers, to said second group of contacts on said second connector via said second group of transformers.

7. A Powered Device (PD) apparatus that utilizes power from a first PSE port, and conveys power from a second PSE port to a second PD, both said PSE ports supplying power to said apparatus via the same computer network cable, said apparatus comprising:
a first connector providing an interface to said computer network cable, said first connector including a first group of contacts receiving power from said first PSE port, and a second group of contacts receiving power from said second PSE port;
a second connector providing an interface to said second PD, said second connector including a first group of contacts and a second group of contacts;
logic circuitry operable to at least convey computer network data between said first connector and said second connector;
a first group of transformers arranged to AC-couple said computer network data between said first connector and said logic circuitry;
a second group of transformers arranged to AC-couple said computer network data between said second connector and said logic circuitry;
a first full-wave rectifier circuit with inputs connected to said first group of contacts on said first connector via said first group of transformers;
a second full-wave rectifier circuit with inputs connected to said second group of contacts on said second connector;
a Powered Device (PD) controller circuit with inputs connected to the outputs of both said first full-wave rectifier circuit and said second full-wave rectifier circuit;
a power supply circuit with inputs connected to the outputs of said PD controller circuit, said power supply circuit supplying power to at least said logic circuitry; and
circuit pathways that convey DC power from said second group of contacts on said first connector to said second group of contacts on said second connector via said second group of transformers.

8. The apparatus of claim 7 wherein said second full-wave rectifier inputs are connected to said second group of contacts on said second connector via said second group of transformers.

9. The apparatus of claim 7 wherein said circuit pathways convey DC power from said second group of contacts on said first connector via said first group of transformers, to said first group of contacts on said second connector via said second group of transformers.

10. A Powered Device (PD) apparatus that utilizes power from a first PSE port, and conveys power from a second PSE port to a second PD, both said PSE ports supplying power to said apparatus via the same computer network cable, said apparatus comprising:
a first connector providing an interface to said computer network cable, said first connector including a first group of contacts receiving power from said first PSE port, and a second group of contacts receiving power from said second PSE port;
a second connector providing an interface to said second PD, said second connector including a first group of contacts and a second group of contacts;
logic circuitry operable to at least convey computer network data between said first connector and said second connector;
a first group of transformers arranged to AC-couple said computer network data between said first connector and said logic circuitry;
a second group of transformers arranged to AC-couple said computer network data between said second connector and said logic circuitry;
a first full-wave rectifier circuit with inputs connected to said first group of contacts on said first connector via said first group of transformers;
a second full-wave rectifier circuit;
a power switch with at least two states:
a first state wherein said power switch routes power from said second group of contacts on said first connector to the inputs of said second full-wave rectifier circuit; and
a second state wherein said power switch routes power from said second group of contacts on said first connector to said second group of contacts on said second connector;
a Powered Device (PD) controller circuit with inputs connected to the outputs of both said first full-wave rectifier circuit and said second full-wave rectifier circuit; and
a power supply circuit with inputs connected to the outputs of said PD controller circuit, said power supply circuit supplying power to at least said logic circuitry.

11. The apparatus of claim 10 and further comprising control circuitry operable to:
sense the voltage between the inputs of said first full-wave rectifier circuit;
sense the voltage between the inputs of said second full-wave rectifier circuit;
set said power switch to said second state in response to two conditions both being true concurrently, said two conditions are:
magnitude of said voltage between the inputs of said first full-wave rectifier circuit being above a predetermined threshold, and
magnitude of said voltage between the inputs of said second full-wave rectifier circuit being below another predetermined threshold; and
set said power switch to said first state otherwise.

12. The apparatus of claim 10 wherein the state of said power switch is set manually by a user.

13. The apparatus of claim 10 wherein the state of said power switch is set in response to a command message contained within said computer network data received by said logic circuitry.

14. A Powered Device (PD) apparatus that utilizes power from a first PSE port, and conveys power from a second PSE port to a second PD, both said PSE ports supplying power to said apparatus via the same computer network cable, said apparatus comprising:
a first connector providing an interface to said computer network cable, said first connector including a first group of contacts receiving power from said first PSE port, and a second group of contacts receiving power from said second PSE port;
a second connector providing an interface to said second PD, said second connector including a first group of contacts and a second group of contacts;
logic circuitry operable to at least convey computer network data between said first connector and said second connector;
a first group of transformers arranged to AC-couple said computer network data between said first connector and said logic circuitry;
a second group of transformers arranged to AC-couple said computer network data between said second connector and said logic circuitry;
a first full-wave rectifier circuit with inputs connected to said first group of contacts on said first connector via said first group of transformers;
a second full-wave rectifier circuit with inputs connected to said second group of contacts on said first connector;
a first Powered Device (PD) controller circuit with inputs connected to the outputs of said first full-wave rectifier circuit;
a second PD controller circuit with inputs connected to the outputs of said second full-wave rectifier circuit;
a power supply circuit with inputs connected to the outputs of both said PD first controller circuit and said second PD controller circuit, said power supply circuit supplying power to at least said logic circuitry; and
a power switch connected from the inputs of said second full-wave rectifier circuit to said second group of contacts on said second connector.

15. The apparatus of claim 14 wherein the inputs of said second full-wave rectifier circuit are connected to said second group of contacts on said first connector via said first group of transformers.

16. The apparatus of claim 14 wherein said power switch is connected to said second group of contacts on said second connector via said second group of transformers.

17. The apparatus of claim 14 and further comprising control circuitry operable to open said power switch in response to voltage at the output of said first rectifier circuit being below a predetermined threshold and voltage at the output of said second rectifier circuit being below a predetermined threshold.

18. The apparatus of claim 14 wherein said second PD controller circuit has a disabled state, the characteristics of said disable state comprising:
input impedance of said second PD controller circuit is above a predetermined minimum; and
input current of said second PD controller circuit is below a predetermined maximum.

19. The apparatus of claim 18 and further comprising control circuitry operable to put said second PD controller circuit in said disabled state in response to the voltage at the output of said first rectifier circuit being above a predetermined threshold.

20. The apparatus of claim 18 and further comprising control circuitry operable to close said power switch after a predetermined delay following said second PD controller circuit being disabled.

21. The apparatus of claim 18 and further comprising control circuitry operable to close said power switch in response to said second PD controller circuit being disabled and voltage at the output of said second full-wave rectifier circuit being below a predetermined threshold.
